(19) United States
(12) Patent Application Publication
(10) Pub. No.: US 2025/0024828 A1
(43) Pub. Date: Jan. 23, 2025

(54) SYSTEMS AND METHODS TO MONITOR ANIMALS IN A GARAGE

(71) Applicant: Ford Global Technologies, LLC, Dearborn, MI (US)

(72) Inventors: Stuart C. Salter, White Lake, MI (US); Brendan Diamond, Grosse Pointe, MI (US); William Wurz, San Francisco, CA (US); Kevin King, Detroit, MI (US); Bret Barhoover, Chanhassen, MN (US); Paul Edward Guzman, Clawson, MI (US)

(73) Assignee: Ford Global Technologies, LLC, Dearborn, MI (US)

(21) Appl. No.: 18/355,312

(22) Filed: Jul. 19, 2023

(51) Int. Cl. A01M 29/10; A01M 29/16; B60Q 1/02; B60Q 5/00; E05F 15/73

(52) U.S. Cl. CPC A01M 29/10; A01M 29/16; B60Q 1/02; B60Q 5/005; E05F 15/73; A01K 15/023; A01K 29/005; E05Y 2400/44; E05Y 2900/106

(57) ABSTRACT

A vehicle configured to monitor animals in a garage and perform remedial actions is disclosed. The vehicle may include a sensor configured to detect a presence of an animal in a garage interior portion and a garage exterior portion. The vehicle may further include a processor configured to obtain inputs from the sensor. Based on the inputs obtained from the sensor, the processor may determine that the animal may be approaching the garage interior portion or may be present in the garage interior portion. The processor may be further configured to perform a first action when the animal may be approaching the garage interior portion and a second action when the animal may be present in the garage interior portion.

### FIELD

The present disclosure relates to vehicles, and more particularly to a vehicle that may monitor animals in a garage.

### BACKGROUND

Many users have concerns related to garage security, e.g., security of a home garage. Some users use monitoring or security devices to enhance garage security. Such devices typically include cameras that monitor activity in the garage, and alert the users when a suspicious activity is detected.

Although conventional security devices provide many benefits to the users, these security devices may not be effective in certain scenarios. For example, the conventional security devices may not be effective in alerting the users when animals may be trapped in the garage.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 illustrates a block diagram of an example system to monitor animals in a garage, in accordance with the present disclosure.

FIG. 3 depicts a first example to monitor animals in a garage, in accordance with the present disclosure.

FIG. 4 depicts a second example to monitor animals in a garage, in accordance with the present disclosure.

FIG. 5 depicts a third example to monitor animals in a garage, in accordance with the present disclosure.

FIG. 6 depicts a flow diagram of an example method to monitor animals in a garage, in accordance with the present disclosure.

### DETAILED DESCRIPTION

### Overview

The present disclosure describes a vehicle configured to monitor entry or presence of animals (or any unusual activity) in a garage, and perform one or more remedial actions. The vehicle may use sensors such as vehicle cameras, radar, lidar, etc. to detect a presence of an animal in a garage interior portion and a garage exterior portion (e.g., when a garage door may be open). In some aspects, a vehicle processor may be configured to obtain inputs from the sensor and determine that the animal may be approaching the garage interior portion or the animal may be present in the garage interior portion. Responsive to a determination that the animal may be approaching the garage interior portion, the vehicle processor may perform a first remedial action (first action). On the other hand, responsive to a determination that the animal may be present in the garage interior portion, the vehicle processor may be configured to perform a second remedial action (second action).

The first action may include causing the garage door to move from an open state to a closed state, to ensure that the animal may not enter the garage interior portion. In further aspects, the first action may include controlling one or more vehicle components (such as vehicle speaker, vehicle lights, etc.) or one or more garage components (such as garage lights or an alarm) to scare the animal away. In further aspects, the first action may include moving the vehicle slightly in the garage interior portion to scare the animal away.

In some aspects, when the vehicle processor determines that the animal may be present in the garage interior portion, the vehicle processor may further determine whether the animal is a household pet or other than the household pet (e.g., a stray animal) based on the inputs obtained from the sensors (e.g., the vehicle cameras) and images of a household pet stored in a vehicle memory. Responsive to a determination that the animal may be a stray animal, the vehicle processor may perform the second action that may include causing the garage door to move from a closed state to an open state (e.g., when the garage door may be in the closed state and the stray animal may be present in the garage interior portion). In further aspects, in this case, the second action may include transmitting a notification to a user device indicating a stray animal presence in the garage interior portion. In further aspects, the second action may include determining a stray animal location in the garage interior portion and transmitting the stray animal location to the user device.

On the other hand, responsive to a determination that the animal in the garage interior portion may be the household pet, the vehicle processor may be configured to perform the second action that may include causing the garage door to remain in the closed state (e.g., when the vehicle processor obtains a request to move the garage door from the closed state to the open state). In further aspects, in this case, the second action may include transmitting a notification to a user device indicating a household pet presence in the garage interior portion.

The systems and methods described herein may provide various advantages. For example, the system (e.g., a vehicle) may be configured to provide security in the garage using existing vehicle components. Thus, additional components for garage monitoring/security may not be required. In addition, the vehicle may be configured to perform remedial actions automatically to move to stray animals out of the garage, or to ensure that household pets do not move out of the garage.

The other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

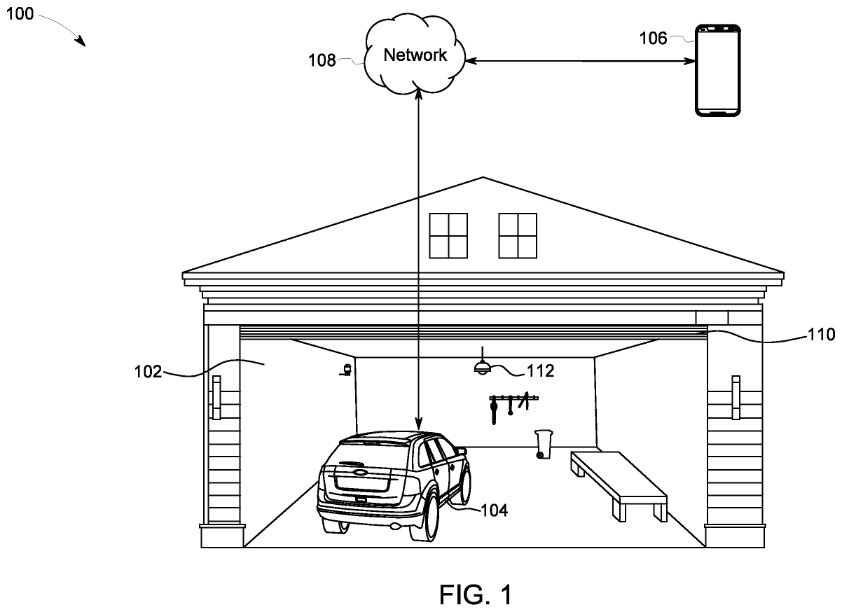

FIG. 1 depicts an example environment 100 in which techniques and structures for providing the systems and methods disclosed herein may be implemented. The environment 100 that may include a garage 102 and a vehicle 104. The garage 102 may be a home garage (as shown in FIG. 1) or any other similar closed parking space that may accommodate one or more vehicles. The garage 102 may include a garage computing device (not shown) that may be configured to transmit/receive information, data, instructions, etc. to/from a user device 106, the vehicle 104 or any other external device via a network 108. Stated another way, the garage 102 may be connected to the vehicle 104 via the garage computing device and the network 108. The garage computing device may be a server or an in-house parking facility computer, laptop, tablet, etc., which a garage operator (e.g., a garage owner or a home owner, not shown) may operate. In further aspects, the user device 106 and the vehicle 104 may be communicatively coupled with each other via the network 108.

The network 108 illustrates an example communication infrastructure in which the connected devices discussed in various embodiments of this disclosure may communicate. The network 108 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The garage 102 may include one or more smart devices, for example, a garage door 110, garage lights 112, etc. The smart devices may communicatively couple with the vehicle 104 via the garage computing device and the network 108. The smart devices may be configured to receive and transmit instructions/notification/inputs from/to the vehicle 104. Further, the vehicle 104 may control operation of one or more smart devices installed in the garage 102 via the garage computing device.

The vehicle 104 may take the form of any passenger or commercial vehicle such as, for example, an off-road vehicle, a car, a crossover vehicle, a van, a minivan, a bus, a truck, etc. Further, the vehicle 104 may be a manually driven vehicle and/or may be configured to operate in partially or fully autonomous mode.

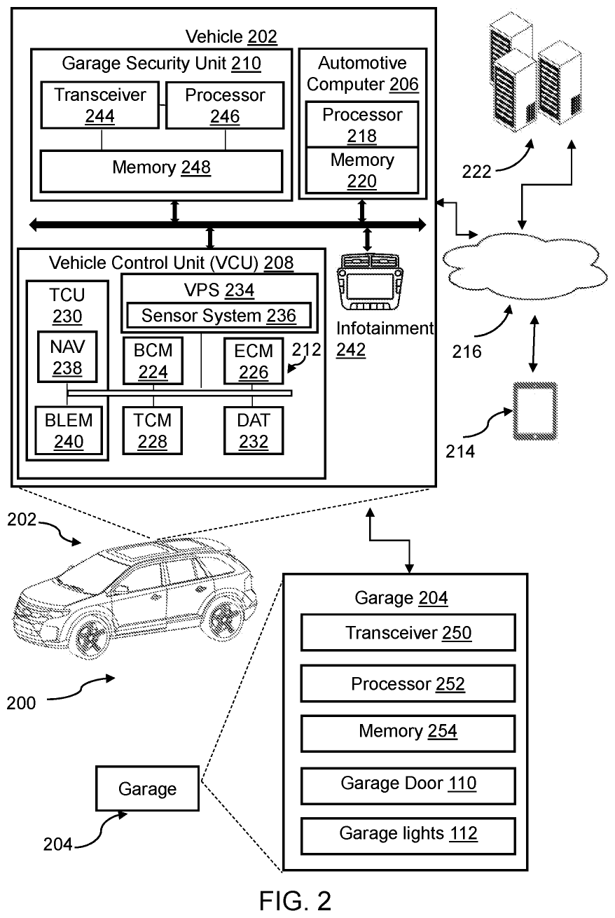

The vehicle 104 may include a garage security unit (shown as garage security unit 210 in FIG. 2) that may be configured to monitor presence of an animal (e.g., stray animal or household pet) in a garage interior portion and a garage exterior portion. For example, the garage security unit may monitor whether a stray animal may be approaching the garage interior portion (e.g., when the garage door 110 may be in an open state). In addition, the garage security unit may monitor presence of stray animals or household pet in the garage interior portion. Responsive to the monitoring, the garage security unit may perform one or more remedial actions. For example, the vehicle 104 may cause the garage door 110 to move from the open state to a closed state when the stray animal may be approaching the garage interior portion. Further, the vehicle 104 may activate one or more vehicle components (e.g., vehicle lights, a vehicle speaker, etc.) or one or more garage components (e.g., the garage lights 112) to scare the stray animal away and keep the stray animal in the garage exterior portion. Further examples of the remedial actions performed by the garage security unit are described later below in conjunction with FIGS. 2-5.

The vehicle 104 and the garage 102 may implement and/or perform operations, as described here in the present disclosure, in accordance with the owner manual and safety guidelines.

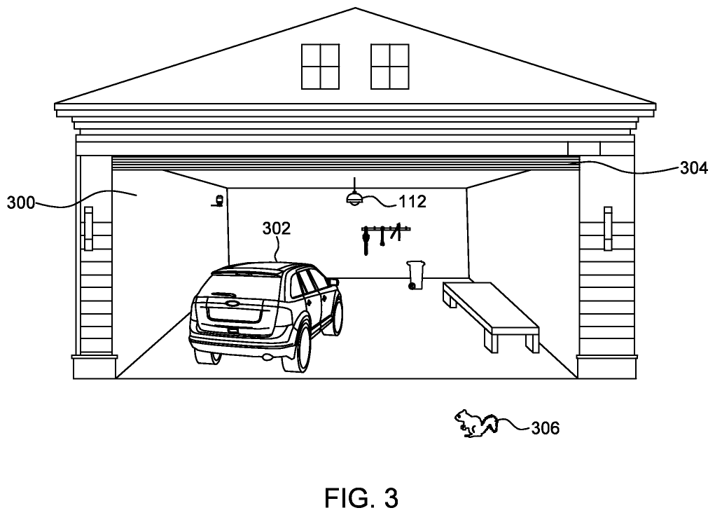

FIG. 2 illustrates a block diagram of an example system 200 to monitor animals in a garage, in accordance with the present disclosure. While explaining FIG. 2, references may be made to FIGS. 3-5.

The system 200 may include a vehicle 202 and a garage 204. The vehicle 202 may be same as the vehicle 104 and the garage 204 may be same as the garage 102.

The vehicle 202 may include an automotive computer 206, a Vehicle Control Unit (VCU) 208 and a garage security unit 210. The VCU 208 may include a plurality of Electronic Control Units (ECUs) 212 disposed in communication with the automotive computer 206.

The system 200 may further include a mobile device 214 (same as the user device 106) that may connect with the automotive computer 206 and/or the garage security unit 210 by using wired and/or wireless communication protocols and transceivers. In some aspects, the mobile device 214 may be associated with a vehicle user/operator (not shown in FIG. 2). In other aspects, the mobile device 214 may be associated with a garage operator or other users (not shown in FIG. 2). The mobile device 214 may communicatively couple with the vehicle 202 via one or more network(s) 216 (same as the network 108). In further aspects, the mobile device 214 may communicatively couple with the garage 204 via the one or more network(s) 216.

In some aspects, the automotive computer 206 and/or the garage security unit 210 may be installed in a vehicle engine compartment (or elsewhere in the vehicle 202). The automotive computer 206 may be or include an electronic vehicle controller, having one or more processor(s) 218 and a memory 220. Moreover, the garage security unit 210 may be separate from the automotive computer 206 (as shown in FIG. 2) or may be integrated as an automotive computer part.

The processor(s) 218 may be disposed in communication with one or more memory devices disposed in communication with the respective computing systems (e.g., the memory 220 and/or one or more external databases not shown in FIG. 2). The processor(s) 218 may utilize the memory 220 to store programs in code and/or to store data for performing aspects in accordance with the disclosure. The memory 220 may be a non-transitory computer-readable memory or computer-readable storage medium storing a garage security program code. The memory 220 can include any one or a combination of volatile memory elements (e.g., dynamic random-access memory (DRAM), synchronous dynamic random-access memory (SDRAM), etc.) and can include any one or more nonvolatile memory elements (e.g., crasable programmable read-only memory (EPROM), flash memory, electronically erasable programmable read-only memory (EEPROM), programmable read-only memory (PROM), etc. The processor 218 may be configured and/or programmed to execute computer-executable instructions stored in the memory 220 for performing one or more functions in accordance with the present disclosure.

In some aspects, the automotive computer 206 may be disposed in communication with one or more server(s) 222 and the mobile device 214. The server(s) 222 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet. In some aspects, the server(s) 222 may include information associated with one or more household pets. For example, the server(s) 222 may store a count of household pets that a vehicle owner or the garage owner may own, type of household pets (such as dogs, cats, etc.), images of each household pet, etc. The server(s) 222 may receive such information from the mobile device 214 or the garage 204. Further, the server(s) 222 may transmit the information to the vehicle 202 in a predefined frequency, or when the vehicle 202 transmit a request to the server(s) 222 seeking the household pet information.

In accordance with some aspects, the VCU 208 may share a power bus with the automotive computer 206, and may be configured and/or programmed to coordinate the data between vehicle 202 systems, connected servers (e.g., the server(s) 222), and other vehicles (not shown in FIG. 2) operating as part of a vehicle fleet. The VCU 208 can include or communicate with any combination of the ECUs 212, such as, for example, a Body Control Module (BCM) 224, an Engine Control Module (ECM) 226, a Transmission Control Module (TCM) 228, a telematics control unit (TCU) 230, a Driver Assistances Technologies (DAT) controller 232, etc. The VCU 208 may further include and/or communicate with a Vehicle Perception System (VPS) 234, having connectivity with and/or control of one or more vehicle sensory system(s) 236. In some aspects, the VCU 208 may control the vehicle operational aspects and implement one or more instruction sets received from the mobile device 214, from one or more instruction sets stored in the memory 220, and/or instruction sets stored in the garage security unit 210.

The vehicle sensory system 236 may include one or more vehicle sensors including, but not limited to, a Radio Detection and Ranging (RADAR or “radar”) sensor configured for detection and localization of objects inside and outside the vehicle 202 using radio waves, sitting area buckle sensors, sitting area sensors, a Light Detecting and Ranging (LiDAR or “lidar”) sensor, door sensors, proximity sensors, temperature sensors, wheel sensors, vehicle internal and external cameras, etc. In some aspects, the vehicle sensory system 236 may be configured to detect presence of an animal in a garage interior portion and a garage exterior portion. The animal may include a stray animal (such as a raccoon, a squirrel, a mouse, etc.) or household pets (such as dogs, cats, etc.). In further aspects, the vehicle sensory system 236 may be configured to monitor other activities in the garage 204 (or any other location) and is not restricted to monitoring of animals in the garage 204. For example, the vehicle sensory system 236 may further monitor presence of a child in the garage 204.

The TCU 230 can be configured and/or programmed to provide vehicle connectivity to wireless computing systems onboard and off board the vehicle 202, and may include a Navigation (NAV) receiver 238 for receiving and processing a GPS signal, a BLE® Module (BLEM) 240, a Wi-Fi transceiver, a UWB transceiver, and/or other wireless transceivers (not shown in FIG. 2) that may be configurable for wireless communication between the vehicle 202 and other systems, computers, and modules. The TCU 230 may be disposed in communication with the ECUs 212 by way of a bus.

In some aspects, the ECUs 212 may control aspects of vehicle operation and communication using inputs from human drivers, inputs from an autonomous vehicle controller, the garage security unit 210, and/or via wireless signal inputs received via the wireless connection(s) from other connected devices, such as the mobile device 214, the server(s) 222, the garage 204 (e.g., a garage computing device associated with the garage 204, as described above in conjunction with FIG. 1) among others.

The BCM 224 generally includes integration of sensors, vehicle performance indicators, and variable reactors associated with vehicle systems, and may include processor-based power distribution circuitry that can control functions associated with the vehicle body such as vehicle lights, windows, security, camera(s), audio system(s), vehicle speakers, display system, door locks and access control, vehicle energy management, and various comfort controls. The BCM 224 may also operate as a gateway for bus and network interfaces to interact with remote ECUs (not shown in FIG. 2).

In some aspects, the DAT controller 232 may provide Level-1 through Level-3 automated driving and driver assistance functionality that can include, for example, active parking assistance, trailer backup assistance, adaptive cruise control, lane keeping, and/or driver status monitoring, among other features. The DAT controller 232 may also provide aspects of user and environmental inputs usable for user authentication.

The DAT controller 232 can further obtain input information via the vehicle sensory system(s) 236, which may include sensors disposed on the vehicle interior and/or exterior (sensors not shown in FIG. 2). The DAT controller 232 may receive the sensor information associated with driver functions, vehicle functions, environmental inputs, and other information.

In some aspects, the automotive computer 206 may connect with an infotainment system 242 that may include a touchscreen interface portion, and may include voice recognition features, biometric identification capabilities that can identify users based on facial recognition, voice recognition, fingerprint identification, or other biological identification means.

The computing system architecture of the automotive computer 206, the VCU 208, and/or the garage security unit 210 may omit certain computing modules. It should be readily understood that the computing environment depicted in FIG. 2 is an example of a possible implementation according to the present disclosure, and thus, it should not be considered limiting or exclusive.

In accordance with some aspects, the garage security unit 210 may be executed as part of and/or integrated with the ECUs 212. The garage security unit 210, regardless of whether it is integrated with the automotive computer 206 or the ECUs 212, or whether it operates as an independent computing system in the vehicle 202, may include a vehicle transceiver 244, a vehicle processor 246, and a vehicle computer-readable memory 248, which may be communicatively coupled to each other. The vehicle memory 248 may store the information associated with the household pets. In some aspects, the vehicle memory 248 may obtain the information associated with the household pets from the server(s) 222 or from the mobile device 214. In further aspects, the vehicle memory 248 may store information associated with the garage 204. The information associated with the garage 204 may include, for example, garage boundary details, images of the garage 204 captured by the vehicle exterior cameras, and/or the like. In addition, the vehicle memory 248 may store user preferences associated with garage monitoring. The user preferences may include, for example, settings to monitor specific types of entities (e.g., animals) and not to monitor other types of entities (e.g., adults), sensitivity levels, threshold values, alert mechanisms, etc.

The vehicle transceiver 244 may be configured to receive information/inputs from one or more external devices or systems, e.g., the mobile device 214, the server(s) 222, the garage 204 and/or the like via the network 216. The vehicle transceiver 244 may store the received information/inputs in the vehicle memory 248. Further, the vehicle transceiver 244 may transmit notifications (e.g., alert/alarm signals) to the external devices or systems (such as components associated with the garage 204). In addition, the vehicle transceiver 244 may be configured to receive information/inputs from vehicle components such as the infotainment system 242, the vehicle sensory system 236, and/or the like. Further, the vehicle transceiver 244 may transmit notifications (e.g., alert/alarm/activation signals) to the vehicle components such as the infotainment system 242, vehicle speakers, vehicle lights, etc.

The garage 204 may include a plurality of components including, but not limited to, a garage transceiver 250, a garage processor 252, a garage memory 254, the garage door 110, and the garage lights 112, etc., which may be communicatively coupled to each other. In some aspects, the garage transceiver 250, the garage processor 252 and the garage memory 254 may be part of the garage computing device described above in conjunction with FIG. 1.

The garage memory 254 may store information associated with the garage 204. The information associated with the garage 204 may include, for example, the garage boundary details, garage light locations, etc. Further, the garage memory 254 may store programs in code and/or store data for performing various garage operations in accordance with the present disclosure. Specifically, the garage processor 252 may be configured and/or programmed to execute computer-executable instructions stored in the garage memory 254 for performing various garage security functions in accordance with the present disclosure. Consequently, the garage memory 254 may be used for storing code and/or data code and/or data for performing operations in accordance with the present disclosure.

In some aspects, the garage processor 252 may be disposed in communication with one or more memory devices (e.g., the garage memory 254 and/or one or more external databases (not shown in FIG. 2)).

In some aspects, the garage transceiver 250 may be configured to receive the inputs/notification/data from the vehicle transceiver 244. The garage transceiver 250 may be configured to store the received inputs/notification/data in the garage memory 254. For example, the garage transceiver 250 may receive activation signals from the vehicle transceiver 244 to move the garage door 110 between a closed state and an open state, request signals to provide garage door status (e.g., whether the garage door 110 may be in the closed state or the open state), activation signals to activate the garage lights 112, etc.

In operation, the vehicle processor 246 may determine that the vehicle 202 may be located or parked in the garage 204. Responsive to determining that the vehicle 202 may be parked in the garage 204, the vehicle processor 246 may determine/identify garage boundary (or entrance area of the garage 204). In some aspects, the vehicle processor 246 may receive inputs from the vehicle sensory system 236 and may identify the garage boundary based on the inputs obtained from the vehicle sensory system 236. In further aspects, the vehicle processor 246 may obtain the boundary details from the vehicle memory 248 (that may pre-store garage boundary details) and identify the garage boundary based on the obtained boundary details. In further aspects, the vehicle processor 246 may obtain the boundary details from the server 222 or the garage memory 254.

Further, the vehicle processor 246 may determine that the vehicle 202 may be in a key-off mode (e.g., vehicle ignition may be turned-off) and a garage security mode in the vehicle 202 may be enabled. In some aspects, the vehicle user may enable the garage security mode manually by using the infotainment system 242, an actuator, or via the mobile device 214. In further aspects, the garage security mode may be enabled automatically based on the user preferences stored in the vehicle memory 248. For example, the vehicle 202 may automatically enable the garage security mode when the vehicle 202 may be parked in the garage 204.

Responsive to a determination that the vehicle 202 may be parked in the garage 204, the vehicle 202 may be in the key-off mode and the garage security mode may be enabled, the vehicle processor 246 may perform garage monitoring. Specifically, the vehicle processor 246 may obtain, via the vehicle transceiver 244, inputs from the vehicle sensory system 236 and may detect presence of animals (or other things) in the garage interior portion and the garage exterior portion based on the obtained inputs. For example, the vehicle processor 246 may obtain inputs from one or more of the radar, lidar, vehicle exterior cameras, etc. simultaneously or in a predetermined sequential manner (e.g., obtaining inputs from the vehicle exterior camera responsive to obtaining inputs from radar, lidar, etc.) and detect an animal presence (or any other activity) based on the obtained inputs.

In further aspects, the vehicle processor 246 may determine a state of charge (SoC) level of a vehicle battery and compare the SoC level with a predefined threshold value (that may be pre-stored in the vehicle memory 248). In some aspects, the vehicle processor 246 may obtain the inputs from the vehicle sensory system 236 when the SoC level may be greater than the predefined threshold value. Stated another way, the vehicle processor 246 may first determine that the SoC level may be greater than the threshold value, and then obtain inputs from the vehicle sensory system 236 responsive to a determination that the SoC level is greater than the threshold value.

Responsive to detecting animal presence in the garage interior portion and/or the garage exterior portion, the vehicle processor 246 may determine that the detected animal may be approaching the garage interior portion or the animal may be present in the garage interior portion based on the inputs from the vehicle sensory system 236. The vehicle processor 246 may perform a first action when the detected animal may be approaching the garage interior portion and perform a second action when the animal may be present in the garage interior portion. Specifically, the vehicle processor 246 may perform the first action when a stray animal may be approaching the garage interior portion, and may perform the second action when the stray animal or a household pet may be present in the garage interior portion. In some aspects, the vehicle processor 246 may perform the first action or the second action based on the user preferences stored in the vehicle memory 248. The details of such determination and the first/second actions may be understood in conjunction with FIGS. 3-5 described below.

FIG. 3 depicts a first example to monitor animals in a garage 300, in accordance with the present disclosure. The garage 300 may be same as the garage 102, 204. FIG. 3 further depicts a vehicle 302 that may be parked inside the garage 300. The vehicle 302 may be same as the vehicle 104, 202. As depicted in FIG. 3, a garage door 304 (same as garage door 110) may be in an open state and an animal 306 may be approaching the garage interior portion (e.g., via the garage door 304). The animal 306 may be a stray animal (hereinafter referred to as stray animal 306).

In some aspects, the vehicle processor 246 may determine whether the garage door 304 may be in the open state or the closed state based on inputs obtained from the garage 300. Specifically, the vehicle processor 246 may transmit a request signal (e.g., via the vehicle transceiver 244) to the garage transceiver 250 seeking status associated with the garage door 304. Responsive to transmitting the request signal, the vehicle processor 246 may receive inputs associated with garage door status from the garage transceiver 250. The vehicle processor 246 may then determine that the garage door 304 may be in the open state based on the inputs obtained from the garage transceiver 250.

Responsive to a determination that the garage door 304 may be in the open state (and the garage security mode may be enabled), the vehicle processor 246 may obtain inputs from the vehicle sensory system 236 and determine that the stray animal 306 may be approaching the garage interior portion. Alternatively, the vehicle processor 246 may obtain inputs from the vehicle sensory system 236 and determine that the stray animal 306 may be approaching the garage interior portion without determining that the garage door 304 may be in the open state.

In additional aspects, the vehicle processor 246 may identify the garage boundary (as described above) and determine that the stray animal 306 may have crossed the garage boundary based on the inputs from the vehicle sensory system 236. The vehicle processor 246 may determine that the stray animal 306 may be approaching the garage interior portion when the stray animal 306 crosses the garage boundary.

Responsive to a determination that the stray animal 306 may be approaching the garage interior portion, the vehicle processor 246 may perform the first action. In some aspects, the first action may include causing the garage door 304 to move from the open state to the closed state. Specifically, the vehicle processor 246 may transmit a control signal to the garage processor 252 (e.g., via the vehicle transceiver 244 and the garage transceiver 250) and cause the garage door 304 to move from the open state to the closed state.

In further aspects, the first action may include activating one or more vehicle components (via the BCM 224) to scare the stray animal 306 away and keep the stray animal 306 in the garage exterior portion. The vehicle components may include vehicle lights, vehicle speaker, etc. In some aspects, the vehicle processor 246 may cause the vehicle lights to activate in a predetermined manner and may cause the vehicle speaker to make noise at a predetermined volume, which may be based on the user preferences. The vehicle processor 246 may further deactivate the vehicle components after a predetermined time duration.

In additional aspects, the first action may include causing the vehicle 302 to move a predetermined distance or slightly (and remain in the garage interior portion) to scare the stray animal 306. Specifically, the vehicle transceiver 244 may transmit a control signal to the VCU 208 (e.g., the DAT controller 232) to move the vehicle 302 inside the garage 204.

In further aspects, the first action may include activating one or more garage components to scare the stray animal 306. The garage component may include garage lights 112, garage alarm, etc. Specifically, the vehicle processor 246 may transmit a control signal (via the vehicle transceiver 244 and the garage transceiver 250) to the garage processor 252 to activate the garage components. In some aspects, the vehicle processor 246 may further transmit a control signal to the garage processor 252 to deactivate the garage components after a predetermined time duration.

In further aspects, the first action may include transmitting a notification to the mobile device 214 indicating that the stray animal 306 may be approaching the garage interior portion. Specifically, the vehicle processor 246 may transmit the notification to the mobile device 214 via the vehicle transceiver 244.

In further aspects, the vehicle processor 246 may be configured to characterize the stray animal 306 based on the inputs obtained from the vehicle sensory system 236. Specifically, the vehicle processor 246 may obtain images captured by the vehicle exterior camera, perform image processing, and characterize the stray animal 306 based on the image processing. For example, the vehicle processor 246 may characterize whether the stray animal 306 may be big or small. In some aspects, the vehicle processor 246 may further identify a stray animal type, e.g., stray dog, squirrel, raccoon, etc. The vehicle processor 246 may further transmit information associated with such determination/characterization to the mobile device 214 via the vehicle transceiver 244.

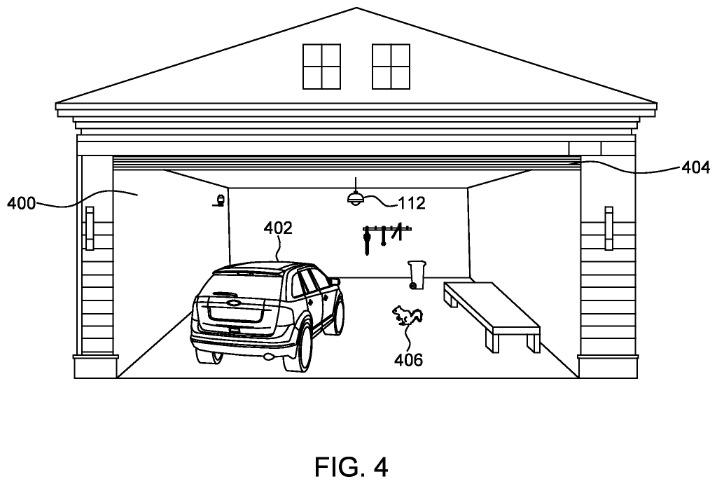

FIG. 4 depicts a second example to monitor animals in a garage 400, in accordance with the present disclosure. The garage 400 may be same as the garage 102, 204, and 300. FIG. 4 depicts a vehicle 402 that may be parked inside the garage 400 and an animal 406 (e.g., a stray animal 406) may be located in the garage interior portion. The vehicle 402 may be same as the vehicle 104, 202 and 302, and the stray animal 406 may be same as the stray animal 306.

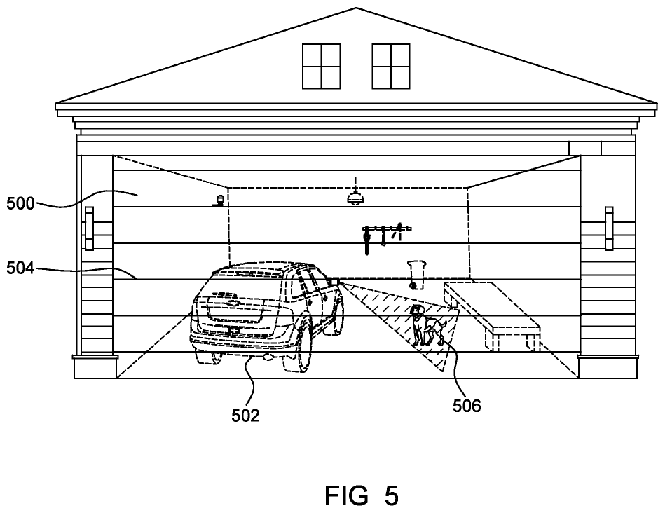

As described above, the vehicle processor 246 may obtain inputs from the vehicle sensory system 236, and may determine that an animal may be present in the garage interior portion based on the obtained inputs. In some aspects, the vehicle processor 246 may additionally determine whether the detected animal is a stray animal (e.g., the stray animal 406) or a household pet (e.g., a household pet 506, as depicted in FIG. 5 and described later). Specifically, the vehicle processor 246 may obtain information associated with the household pet from the vehicle memory 248 (or the server(s) 222). The information may include a count of household pets, types of household pets (such as dog, cat, etc.), images of each household pet etc., owned by the vehicle owner or the garage owner. In some aspects, the vehicle processor 246 may obtain images of garage interior portion from the vehicle sensory system 236 (e.g., from vehicle exterior camera), and may compare the garage interior portion images with the images of the household pets. Responsive to the comparison, the vehicle processor 246 may determine whether the stray animal 406 or the household pet may be present in the garage interior portion. Responsive to a determination that the stray animal 406 may be present in the garage interior portion (e.g., the stray animal 406 may have crossed the garage boundary), the vehicle processor 246 may perform the second action, as described below.

The vehicle processor 246 may first determine whether a garage door 404 (same as the garage door 304) may be in the open state or the closed state, as described above. The vehicle processor 246 may perform the second action based on the determination of the garage door status. In some aspects, the second action may include causing the garage door 404 to move from the closed state to the open state responsive to a determination that the garage door 404 may be in the closed state and the stray animal 406 may be trapped or present in the garage interior portion. On the other hand, if the garage door 404 is already in the open state when the vehicle processor 246 determines that the stray animal 406 may be present in the garage interior portion, the vehicle processor 246 may keep or maintain the garage door 404 in the open state.

In further aspects, the second action may include activating one or more vehicle components to scare the stray animal 406 away to move the stray animal 406 from the garage interior portion to the garage exterior portion. The vehicle components may include the vehicle lights, the vehicle speaker, etc. The second action may further include causing the vehicle 402 to move slightly (and remain in the garage 204) to scare the stray animal 406. In further aspects, the second action may include activating one or more garage components to scare the stray animal 406, as described above in conjunction with FIG. 3.

In further aspects, the second action may include transmitting a notification to the mobile device 214 to indicate that the stray animal 306 may be trapped or present in the garage interior portion. Specifically, the vehicle processor 246 may transmit the notification to the mobile device 214 via the vehicle transceiver 244. The notification may further include characterization of the stray animal 406, as described above in conjunction with FIG. 3.

In further aspects, the second action may include determining a stray animal location based on the inputs obtained from the vehicle sensory system 236 responsive to a determination that the stray animal 406 may be present in the garage interior portion. Responsive to determining the stray animal location, the vehicle processor 246 may store the stray animal location in the vehicle memory 248 and may track the stray animal location using the inputs obtained from the vehicle sensory system 236. The vehicle processor 246 may further transmit the stray animal location to the mobile device 214 via the vehicle transceiver 244.

FIG. 5 depicts a third example to monitor animals in a garage 500, in accordance with the present disclosure. The garage 500 may be same as the garage 102, 204, 300, and 400. FIG. 5 depicts a vehicle 502 that may be parked inside the garage 500 and an animal 506 (e.g., the household pet 506) may be present in the garage interior portion. The vehicle 502 may be same as the vehicle 104, 202 302, 402.

As described above, the vehicle processor 246 may obtain inputs from the vehicle sensory system 236, and may determine that an animal may be present in the garage interior portion based on the obtained inputs. In some aspects, the vehicle processor 246 may determine whether the animal is a stray animal (e.g., the stray animal 406) or the household pet 506 (as described above in conjunction with FIG. 4). The vehicle processor 246 may perform the second action responsive to a determination that the household pet 506 may be present in the garage interior portion. The details of the second action in such a scenario are described below.

In operation, when the vehicle user (or any other user) actuates a button to move the garage door (e.g., a garage door 504, same as the garage door 110) from the closed state to the open state, the vehicle processor 246 may obtain such user request from the garage transceiver 250. Responsive to obtaining such user request, the vehicle processor 246 may obtain inputs from the vehicle sensory system 236. The vehicle processor 246 may then determine that the household pet 506 may be present in the garage interior portion (e.g., in proximity to the vehicle 502) based on the inputs, as described above. Responsive to a determination that the household pet 506 may be present in the garage interior portion, the vehicle processor 246 may perform the second action. In some aspects, the second action may include causing the garage door 504 to remain in the closed state such that the household pet 506 may remain in the garage interior portion. In further aspects, the second action may include transmitting a notification to the mobile device 214 (or activating a sound exciter or any other component) to indicate that the household pet 506 may be in the garage interior portion, before enabling the garage door 504 to open. The user may view/hear the notification and may move the household pet 506 away from the garage interior portion, before the vehicle processor 246 may open the garage door 504.

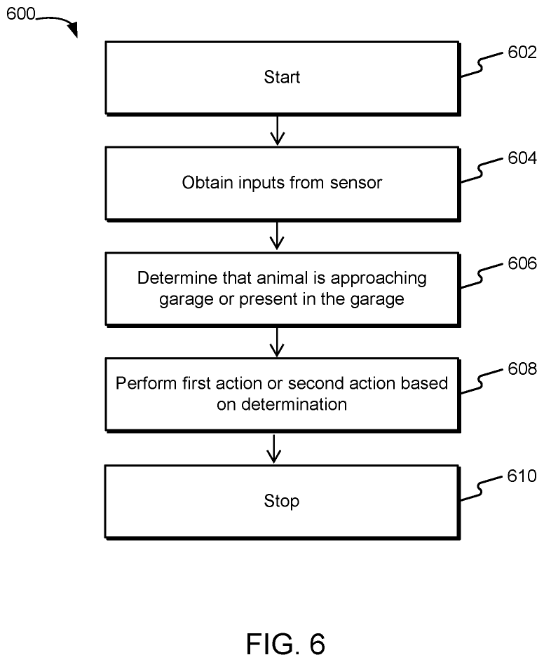

FIG. 6 depicts a flow diagram of an example method 600 to monitor animals in a garage, in accordance with the present disclosure. FIG. 6 may be described with continued reference to prior figures, including FIGS. 1-5. The following process is exemplary and not confined to the steps described hereafter. Moreover, alternative embodiments may include more or less steps than are shown or described herein and may include these steps in a different order than the order described in the following example embodiments.

Referring to FIG. 6, at step 602, the method 600 may commence. At step 604, the method 600 may include obtaining, by the vehicle processor 246, inputs from the vehicle sensory system 236 (or sensor) to detect presence of an animal in the garage interior portion and the garage exterior portion.

At step 606, the method 600 may include determining, by the vehicle processor 246, that an animal may be approaching the garage interior portion or may be present in the garage interior portion based on the inputs obtained from the sensor. The animal may be a stray animal or a household pet.

At step 608, the method 600 may include performing, by the vehicle processor 246, a first action when the animal may be approaching the garage interior portion and a second action when the animal may be present in the garage interior portion.

The method 600 may end at step 610.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a sensor configured to detect a presence of an animal in one or more of a garage interior portion or a garage exterior portion; and
a processor communicatively coupled to the sensor, wherein the processor is configured to:
obtain inputs from the sensor;
determine that the animal is approaching the garage interior portion or is present in the garage interior portion based on the inputs obtained from the sensor; and
perform a first action when the animal is approaching the garage interior portion and a second action when the animal is present in the garage interior portion.

2. The vehicle of claim 1, wherein the processor is further configured to:
determine that a garage door is in an open state; and
determine that the animal is approaching the garage interior portion responsive to a determination that the garage door is in the open state,
wherein the first action comprises causing the garage door to move from the open state to a closed state based on the determination that the animal is approaching the garage interior portion.

3. The vehicle of claim 2, wherein the first action further comprises activating a vehicle component or a garage component to keep the animal in the garage exterior portion.

4. The vehicle of claim 3, wherein the vehicle component comprises at least one of vehicle lights and a vehicle speaker.

5. The vehicle of claim 3, wherein the processor is further configured to:
identify a boundary of a garage based on the inputs obtained from the sensor; and
determine that the animal is approaching the garage interior portion based on the identification of the boundary.

6. The vehicle of claim 1, wherein the first action further comprises causing the vehicle to move a predetermined distance in the garage interior portion.

7. The vehicle of claim 1, wherein the processor is further configured to:
obtain information associated with a household pet, wherein the information comprises household pet images; and
determine whether the animal is the household pet based on the inputs obtained from the sensor and the information associated with the household pet.

8. The vehicle of claim 7, wherein the processor is further configured to:
determine that a garage door is in a closed state; and
determine that the animal is other than the household pet,
wherein the second action comprises causing the garage door to move from the closed state to an open state based on a determination that the garage door is in the closed state and the animal is other than the household pet.

9. The vehicle of claim 8, wherein the second action further comprises transmitting a notification to a user device indicating the animal is in the garage interior portion.

10. The vehicle of claim 8, wherein the second action further comprises activating a vehicle component or a garage component to move the animal to the garage exterior portion, and wherein the vehicle component comprises at least one of vehicle lights and a vehicle speaker.

11. The vehicle of claim 8, wherein the second action further comprises determining an animal location based on the inputs obtained from the sensor responsive to a determination that the animal is present in the garage interior portion, and transmitting the animal location to a user device.

12. The vehicle of claim 7, wherein the processor is further configured to:
obtain a request to move a garage door from a closed state to an open state; and
determine that the animal is the household pet,
wherein the second action comprises causing the garage door to remain in the closed state based on a determination that the animal is the household pet.

13. The vehicle of claim 12, wherein the second action further comprises transmitting a notification to a user device indicating that the household pet is present in the garage interior portion.

14. The vehicle of claim 1, wherein the processor is further configured to:
determine that a state of charge (SoC) level of a vehicle battery is greater than a threshold value; and
obtain the inputs from the sensor responsive to a determination that the SoC level is greater than the threshold value.

15. A method comprising:
obtaining, by a processor, inputs from a sensor, wherein the sensor is configured to detect a presence of an animal in one or more of a garage interior portion or a garage exterior portion;
determining, by the processor, that the animal is approaching the garage interior portion or is present in the garage interior portion based on the inputs obtained from the sensor; and
performing, by the processor, a first action when the animal is approaching the garage interior portion and a second action when the animal is present in the garage interior portion.

16. The method of claim 15 further comprising:
determining that a garage door is in an open state; and
determining that the animal is approaching the garage interior portion responsive to a determination that the garage door is in the open state,
wherein the first action comprises causing the garage door to move from the open state to a closed state based on the determination that the animal is approaching the garage interior portion.

17. The method of claim 15, wherein the method further comprises:
obtaining information associated with a household pet, wherein the information comprises household pet images; and
determining whether the animal is the household pet based on the inputs obtained from the sensor and the information associated with the household pet.

18. The method of claim 17 further comprising:
determining that a garage door is in a closed state; and
determining that the animal is other than the household pet,
wherein the second action comprises causing the garage door to move from the closed state to an open state based on a determination that the garage door is in the closed state and the animal is other than the household pet.

19. The method of claim 17 further comprising:
obtaining a request to move a garage door from a closed state to an open state; and
determining that the animal is the household pet,
wherein the second action comprises causing the garage door to remain in the closed state based on a determination that the animal is the household pet.

20. A non-transitory computer-readable storage medium having instructions stored thereupon which, when executed by a processor, cause the processor to:
obtain inputs from a sensor, wherein the sensor is configured to detect a presence of an animal in one or more of a garage interior portion or a garage exterior portion;
determine that the animal is approaching the garage interior portion or is present in the garage interior portion based on the inputs obtained from the sensor; and
perform a first action when the animal is approaching the garage interior portion and a second action when the animal is present in the garage interior portion.
